(19) United States
(12) Patent Application Publication
(10) Pub. No.: US 2026/0158781 A1
(43) Pub. Date: Jun. 11, 2026

(54) ELEMENT SUBSTRATE, PRINTING HEAD, AND PRINTING APPARATUS

(71) Applicant: CANON KABUSHIKI KAISHA, Tokyo (JP)

(72) Inventor: MINEO SHIMOTSUSA, Tokyo (JP)

(21) Appl. No.: 19/397,662

(22) Filed: Nov. 21, 2025

(30) Foreign Application Priority Data
Dec. 5, 2024 (JP) 2024-212172

(51) Int. Cl. B41J 2/14; B41J 2/045

(52) U.S. Cl. CPC B41J 2/1408; B41J 2/0455; B41J 2/0458; B41J 2/14129; B41J 2202/08

(57) ABSTRACT

An element substrate having a laminate structure, includes, from the bottom: a semiconductor material substrate; plural MOS transistors on the semiconductor material substrate; an insulation layer on the plural MOS transistors; and plural energy generation elements on the insulation layer and configured to be driven by the plural MOS transistors to generate heat to eject a liquid, in which each energy generation element and at least one of the plural MOS transistors are arranged at positions to partially overlap each other in planar view. A heat transfer line formed of a material with higher thermal conductivity than that of a material of the insulation layer is arranged in the insulation layer, and the heat transfer line is arranged at a position in which each energy generation element and a part of the heat transfer line overlap each other in planar view, and is connected to the semiconductor material substrate.

### BACKGROUND

### Field of the Technology

The present disclosure relates to an element substrate for driving a printing element that performs printing by ejecting an ink.

### Description of the Related Art

Regarding ink jet printing heads, a thermal driving method to perform printing is known, in which an energy generation element (a heater) is provided to a portion communicating with an ejection port through which an ink droplet is ejected, the heater is supplied with a current to generate heat, and the ink droplet is ejected onto a printing medium by film boiling of the ink. In addition, an element substrate on which plural heaters are mounted has a configuration to receive a desired signal from a printing apparatus to operate a corresponding driving circuit and supply the heater with the current. To reduce manufacturing cost of the element substrate, a technique of reducing a size of the element substrate by providing a Metal-Oxide Semiconductor Transistor (MOS transistor) immediately below the heater has been disclosed in Japanese Patent Laid-Open No. 2019-142000.

Although the conventional element substrates have achieved the size reduction of the substrate, further improvement is expected.

### SUMMARY

An element substrate according to the present disclosure is an element substrate having a laminate structure, including, from bottom in a laminated direction of the element substrate: a substrate of a semiconductor material; plural Metal-Oxide Semiconductor Transistors (MOS transistors) disposed on the substrate of the semiconductor material; an insulation layer disposed on the plural MOS transistors; and plural energy generation elements disposed on the insulation layer and configured to be driven by the plural MOS transistors to generate heat to eject a liquid, in which each energy generation element and at least one of the plural MOS transistors are arranged at positions to partially overlap each other in planar view, a heat transfer line formed of a material with higher thermal conductivity than that of a material of the insulation layer is arranged in the insulation layer, and the heat transfer line is arranged at a position in which each energy generation element and a part of the heat transfer line overlap each other in planar view and connected to the substrate of the semiconductor material.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic perspective view of a printing apparatus including a printing head according to the present disclosure;

FIG. 2 is a block diagram illustrating a control configuration of the printing apparatus;

FIG. 3 is a diagram illustrating a configuration of a heater and a driving circuit of the heater;

FIG. 4A is a plan view schematically illustrating the printing head;

FIG. 4B is a cross-sectional view schematically illustrating the printing head;

FIG. 4C is a cross-sectional view schematically illustrating the printing head;

FIG. 5 is a diagram describing a temporal change of an interface temperature of a substrate of the printing head;

FIG. 6 is a diagram describing a temporal change of the interface temperature of the substrate of the printing head;

FIG. 7 is a diagram illustrating a configuration of the heater and a driving circuit of the heater;

FIG. 8A is a plan view schematically illustrating the printing head;

FIG. 8B is a cross-sectional view schematically illustrating the printing head; and

FIG. 9 is a diagram illustrating a configuration of the heater and a driving circuit of the heater.

### DESCRIPTION OF THE EMBODIMENTS

Hereinafter, embodiments of the present disclosure are described with reference to the drawings. Note that, it is possible to refer to the plural drawings reciprocally in the descriptions and the drawings below. Additionally, the same or similar configurations are described with common reference numerals, and description of the configuration described with the common reference numeral is omitted as needed.

### Brief Description of Printing Apparatus

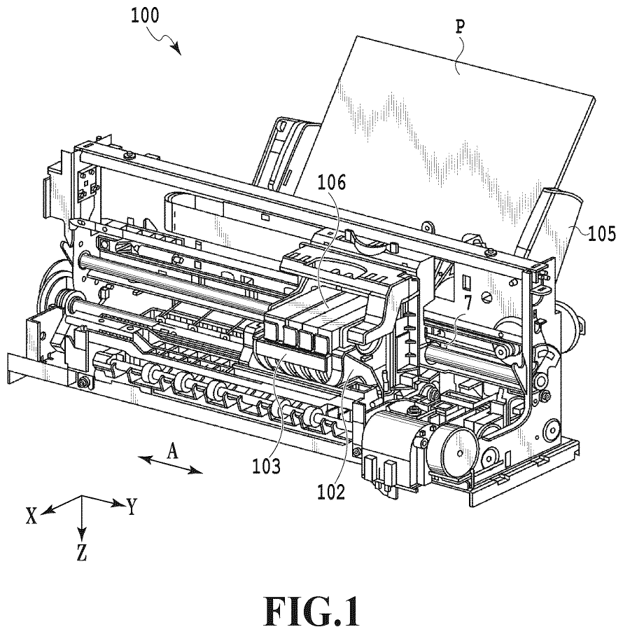

FIG. 1 is a schematic perspective view illustrating an overview of a configuration of a printing apparatus that performs printing by using an ink jet printing head (hereinafter, referred to as a “printing head”) that is a representative example of the present disclosure. As illustrated in FIG. 1, in an ink jet printing apparatus (hereinafter, referred to as a “printing apparatus”) 100, a printing head 103 that performs printing by ejecting an ink (a liquid) according to an ink jet method is mounted on a carriage 102. In addition, the carriage 102 is reciprocally moved in an arrow A direction to perform printing. A printing medium P such as printing paper is fed via a feeding mechanism 105 and conveyed to a printing position, and the printing head 103 ejects the ink onto the printing medium P at the printing position to print an image and the like.

Not only the printing head 103 but also an ink tank 106 retaining the ink to be supplied to the printing head 103 is mounted on the carriage 102 of the printing apparatus 100. The ink tank 106 is freely attachable to and detachable from the carriage 102. The printing apparatus 100 illustrated in FIG. 1 can perform full-color printing. Therefore, four ink cartridges storing inks of cyan (C), magenta (M), yellow (Y), and black (K), respectively, are mounted on the carriage 102. The four ink cartridges are individually attachable and detachable.

The printing head 103 adopts the ink jet method in which the ink is ejected by utilizing heat energy. Therefore, an energy generation element of an Electro-Thermal conversion type (hereinafter, also referred to as a “heater”) is included. The energy generation element is provided to each of ejection ports, and the ink is ejected from the corresponding ejection port by applying a pulse voltage to the corresponding energy generation element according to a printing signal. Note that, the printing apparatus is not limited to the serial type printing apparatus described above, and the present disclosure is also applicable to a full-line type printing apparatus in which the printing head (a line head) in which the ejection ports are arrayed in a width direction of the printing medium is arranged in a conveyance direction of the printing medium.

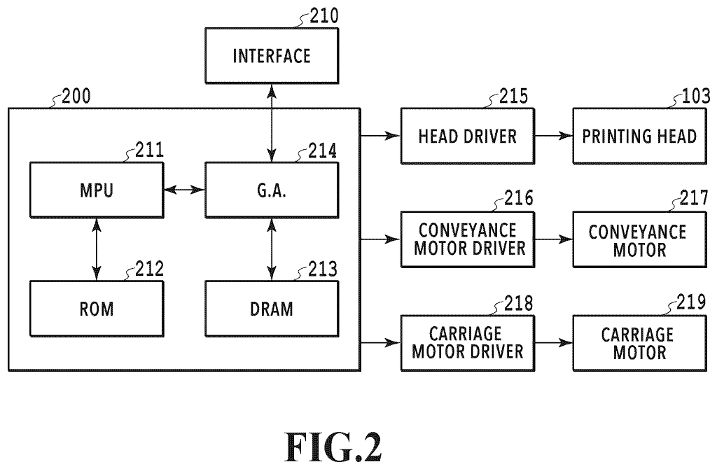

FIG. 2 is a block diagram illustrating a control configuration of the printing apparatus 100 illustrated in FIG. 1. In FIG. 2, a controller 200 includes an MPU 211, a ROM 212, a DRAM 213, and a gate array (G.A.) 214. The MPU 211 is a processor that executes various programs such as a control program. The ROM 212 stores the control program and the like executed by the MPU 211. The DRAM 213 saves printing data or data such as the printing signal supplied to the printing head 103. The gate array 214 controls supplying of the printing signal to the printing head 103. The gate array 214 also controls data transfer among an interface 210, the MPU 211, and the DRAM 213. The interface 210 inputs the printing data to the gate array 214. A head driver 215 drives the printing head 103. A conveyance motor 217 is a motor to convey the printing medium such as the printing paper. A carriage motor 219 is a motor to convey the printing head 103. A conveyance motor driver 216 is a motor driver to drive the conveyance motor 217. A carriage motor driver 218 is a motor driver to drive the carriage motor 219.

Operations of the above-described control configuration are described below. Once the printing data is inputted to the interface 210, the printing data is converted into the printing signal for printing between the gate array 214 and the MPU 211. Then, once the conveyance motor driver 216 drives the conveyance motor 217, the printing medium is conveyed to the printing position. Once the carriage motor driver 218 drives the carriage motor 219, the carriage 102 moves to perform printing. The printing head 103 is driven according to the printing data transmitted to the head driver 215, and the image and the like are printed on the printing medium.

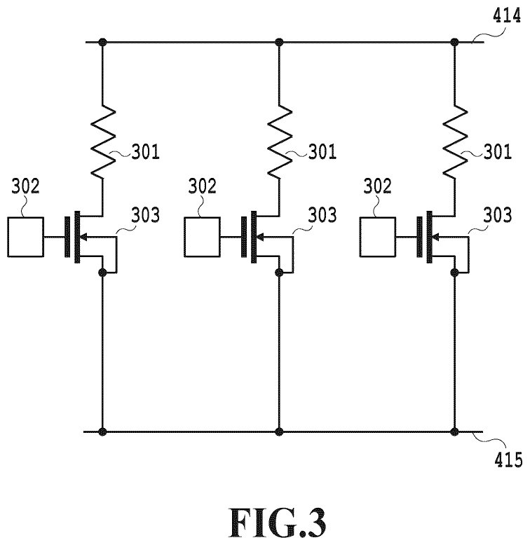

FIG. 3 is a diagram illustrating a circuit configuration of the heater, which forms a printing element, and a driving circuit of the heater. As illustrated in FIG. 3, a heater 301 is connected to a MOS transistor 303 that switches driving of the heater 301. The MOS transistor 303 is connected to a selection circuit 302, and ON/OFF of the MOS transistor 303 is controlled with the selection circuit 302 outputting a selection signal. Thus, a current flows to the desired heater 301, and with the thus-generated heat energy, the ink is ejected onto the printing medium. In this case, a Metal-Oxide Semiconductor Field Effect Transistor (MOSFET) or the like is used as the MOS transistor 303. The selection circuit 302 includes a circuit to output the selection signal (for example, a shift register and a latch circuit), wiring to transfer a signal, wiring to supply power, and the like. Additionally, the driving circuit of the heater may include a voltage conversion circuit to convert a voltage inputted to the MOS transistor 303. The MOS transistor 303 and the selection circuit 302 are collectively called the driving circuit. The printing head 103 includes an element substrate having a laminate structure in which plural units of the configuration illustrated in FIG. 3, each including the heater 301 and the driving circuit thereof, are mounted. In an example of the embodiment described below, the element substrate has the laminate structure described below. From bottom in a laminated direction, a substrate of a semiconductor material, plural MOS transistors disposed on the substrate of the semiconductor material, and an insulation layer disposed on the substrate of the semiconductor material and the plural MOS transistors are laminated. In addition, plural energy generation elements that are disposed on the insulation layer, driven by the plural MOS transistors, and generate heat to eject the ink are laminated. Additionally, a heat transfer line including conductive wiring is arranged in the insulation layer. The heat transfer line may have a multi-layer structure.

### First Embodiment

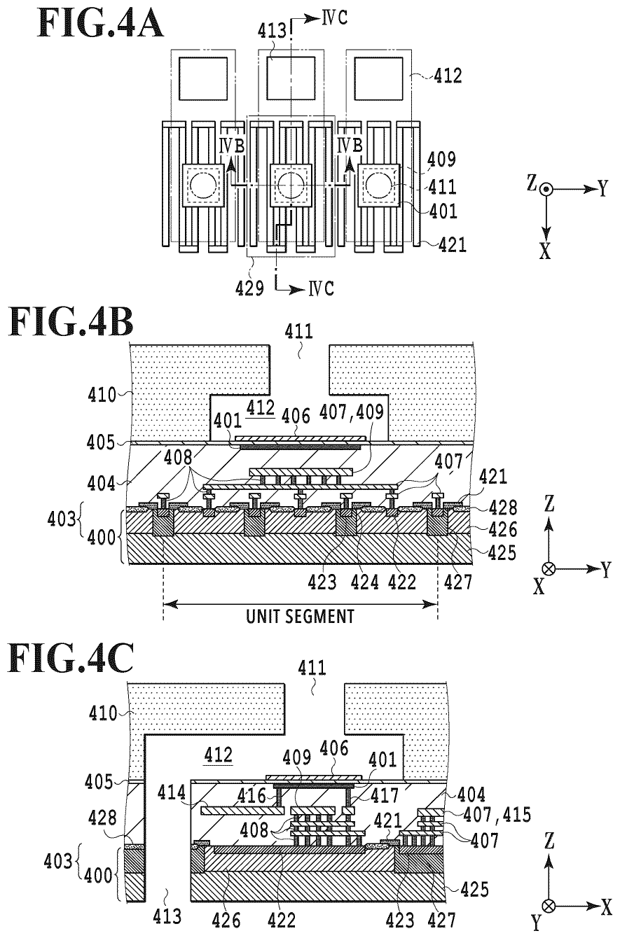

A first embodiment is described with reference to FIGS. 4A, 4B, and 4C. FIG. 4A is a schematic plan view of the printing head 103. FIG. 4B is a schematic cross-sectional view of the printing head 103 taken along a cross-section line IVB-IVB in FIG. 4A. FIG. 4C is a schematic cross-sectional view of the printing head 103 taken along a cross-section line IVC-IVC in FIG. 4A. For example, the printing head 103 is formed on a base substrate 400 (the substrate of the semiconductor material) formed of single-crystal silicon. An insulation layer 404 is arranged on the base substrate 400. For example, the insulation layer 404 is formed of a mineral material of silicon oxide, has electric insulation properties, and electrically separates each type of wiring. Additionally, multi-layer wiring (conductive wiring) 407 is arranged on the base substrate 400. The multi-layer wiring 407 is formed of a metallic material including aluminum or copper as a main component, for example. A via 408 is formed of a metallic material including tungsten or copper as a main component, for example. The uppermost surface of the insulation layer 404 is flattened. Flattening processing is performed by chemical mechanical polishing (CMP), for example. The flattening processing may be performed every time before a formation step of the via 408, the wiring 407, and an energy generation element 401 or after the formation step.

The energy generation element 401 is arranged on the insulation layer 404. The energy generation element 401 is formed of a resistor material such as tantalum nitride silicon or tungsten nitride silicon, for example. A cavitation resistant layer 406 is arranged on the energy generation element 401 with the insulation layer 404 arranged therebetween. The cavitation resistant layer 406 is a film to protect the energy generation element 401, the insulation layer 404, the wiring 407, and the like from cavitation that is caused by driving of the energy generation element 401. The cavitation resistant layer 406 includes the energy generation element 401 in planar view. The cavitation resistant layer 406 is formed of a single layer or laminated layers of a metallic material or an alloy having great mechanical strength and chemical strength such as iridium or tantalum, for example.

An ejection port 411 and a flow channel 412 are formed above the cavitation resistant layer 406 and the insulation layer 404 by a nozzle formation member 410. The nozzle formation member 410 is formed of photosensitive resin, for example. Additionally, a supply port 413 of the ink is formed to penetrate the base substrate 400 and the insulation layer 404. The supply port 413 communicates with the flow channel 412. The supply port 413 may have a commonalized configuration within the chip (not illustrated). The printing head 103 utilizes the heat energy of the energy generation element 401 to generate an air bubble by film boiling of the ink in the flow channel 412 and ejects the ink from the ejection port 411.

A MOS transistor 403 is arranged immediately below the energy generation element 401. The MOS transistor 403 includes three terminals, which are a gate 421, a drain 422, and a source 423. The gate 421 is formed of polysilicon, for example. An area outside of the gate 421 is one segment region 429 (see FIG. 4A) of the MOS transistor 403. In the present embodiment, each segment is formed of six fingers (six gates). For example, 512 segments are arranged in a right and left direction at a pitch of 600 dpi. In addition, for example, the 512 segments are arranged in plural rows on the same substrate. A power feeding line 414 is connected to one end of the energy generation element 401 through a via 416. Another end of the energy generation element 401 is connected to the drain 422 of the MOS transistor 403 through a via 417, and the source 423 of the MOS transistor 403 is connected to a ground line 415. In the present embodiment, a low side switch type having a source grounded configuration is applied. Since the source grounded configuration is used in a desaturated region with a low resistance, it is possible to relatively reduce the size of the MOS transistor 403. Additionally, since the low side switch type can reduce a gate voltage of the MOS transistor 403, it is possible to relatively reduce the size of the selection circuit 302. In the present embodiment, the MOS transistor 403 has an offset gate structure in which the source, the gate, and the drain are asymmetric. The offset gate structure makes a distance between the channel and the drain longer than a distance between the channel and the source to achieve low impurity, and it is possible to attenuate concentration of an electric field even in a case of applying a high voltage and implement high withstand voltage as a result. In the present embodiment, the MOS transistor 403 has an n-type DMOS structure. In this case, DMOS is an abbreviation of a Double-diffused Metal-Oxide Semiconductor. The DMOS structure can implement small power consumption while implementing high withstand voltage and large current. Particularly, the DMOS structure is an effective advantageous structure in a case where a power feeding voltage is equal to or smaller than 100 (V). The segments of the MOS transistor 403 in the present embodiment are separated from each other by source separation, which is separation by using a source line of the MOS transistor 403. In a case where the segments are separated from each other by the source separation, it is unnecessary to provide a dedicated element separation region, and it is possible to relatively reduce the size of the driving circuit. On the base substrate 400, a p-type substrate 425, an n-type well 426, and a p-type well 427 are formed. Additionally, an element separation 428 is formed on a top surface of the base substrate 400. The element separation 428 is formed of silicon oxide, for example.

A heat transfer line 409 is arranged immediately below the energy generation element 401. The heat transfer line 409 is formed of a material with a higher thermal conductivity than that of a material of the insulation layer 404. For example, the semiconductor has a thermal conductivity that is about a hundredfold greater than that of the silicon oxide, and the metal has a thermal conductivity that is about two-hundredfold greater than that of the silicon oxide. It is preferable to arrange the uppermost layer of the heat transfer line 409 to overlap a large proportion (for example, 50% or more) of an area of the energy generation element 401 in planar view. The uppermost layer of the heat transfer line 409 may be arranged to overlap a part of the area of the energy generation element 401 in planar view. That is, since the heat transfer line 409 is formed of the material with a higher thermal conductivity than that of the material of the insulation layer 404, a heat dissipation effect is obtained as long as 10% or more of the area of the energy generation element 401 overlaps the uppermost layer of the heat transfer line 409. This is because a distance between the energy generation element 401 and the heat transfer line 409 in a vertical direction is 1 to 4 [μm], while a length of one side of the energy generation element 401 that is 10 to 40 [μm]. Additionally, it is preferable to arrange the uppermost layer of the heat transfer line 409 to overlap the center of the energy generation element 401 in planar view. This is because a heat generation amount of the energy generation element 401 has a distribution, and the central portion has the highest temperature. Moreover, it is preferable to form the heat transfer line 409 by the wiring 407 that is the closest to the energy generation element 401 in cross-sectional view. This is because, the closer the heat transfer line 409 is to the energy generation element 401, the better the heat dissipation of the heat transfer line 409. Note that, since the capability to store the heat energy of the energy generation element 401 is also required to eject the ink, the heat transfer line 409 may not be the wiring 407 that is the closest to the energy generation element 401 in cross-sectional view depending on an ejection design.

In the present embodiment, the heat transfer line 409 is connected to the base substrate 400 through the via 408 and the wiring 407. The heat generated by the energy generation element 401 dissipates to the base substrate 400 through the heat transfer line 409, the via 408, and the wiring 407. The temperature needs to be about 300 [° C. ] to cause film boiling of the ink. Additionally, greater energy is required to eject the ink, and the temperature of the energy generation element 401 instantaneously reaches 400 [° C.] or higher.

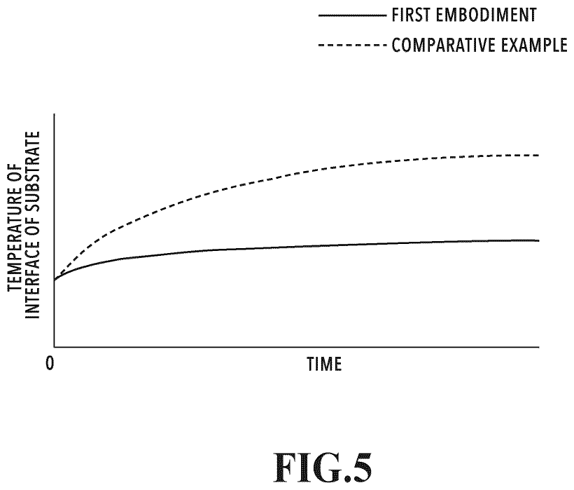

FIG. 5 is a diagram comparing temperature transition of the interface between the base substrate 400 and the insulation layer 404 along with continuous ejection by the printing head in cases with and without a heat dissipation mode of the present embodiment (a comparative example). The heat dissipation mode in the present embodiment indicates a mode of connecting to the base substrate 400 through the heat transfer line 409, the via 408, and the wiring 407. A vertical axis represents the temperature, and a horizontal axis represents time. The time at which the voltage application to the energy generation element 401 starts is an origin O, a solid line represents a case with the heat dissipation mode, and a broken line represents a case without the heat dissipation mode, respectively. The graph illustrated in FIG. 5 is obtained by creating a temperature distribution of the interface by three-dimensional simulation, extracting the maximum temperature, and plotting the temperature to the graph. It is possible to read that the heat generated by the energy generation element 401 is accumulated, and an increase of the temperature of the base substrate 400 in a case with the heat dissipation mode of the present embodiment is half of or less than that in a case without the heat dissipation mode. The time-dependent dielectric breakdown (TDDB) phenomenon that is one of indexes of a lifetime of the MOS transistor 403 depends on the temperature. In general, it is said that, in a case where a temperature of a usage environment becomes 125 [° C.] from 25 [° C.], the lifetime of the MOS transistor 403 is reduced by double digits. Therefore, in a case with the heat dissipation mode of the present embodiment, it is possible to extend the lifetime of the MOS transistor 403.

In addition, in the present embodiment, the heat transfer line 409 is connected to the drain 422 of the MOS transistor 403 of the base substrate 400 through the via 408 and the wiring 407. In the present embodiment, the MOS transistor 403 is arranged immediately below the energy generation element 401, and therefore, it is preferable for the heat to dissipate to the base substrate 400 in the MOS transistor 403. In a case where the heat dissipates to the base substrate 400 outside the MOS transistor 403, a dedicated area is required, and the size of the element substrate is increased.

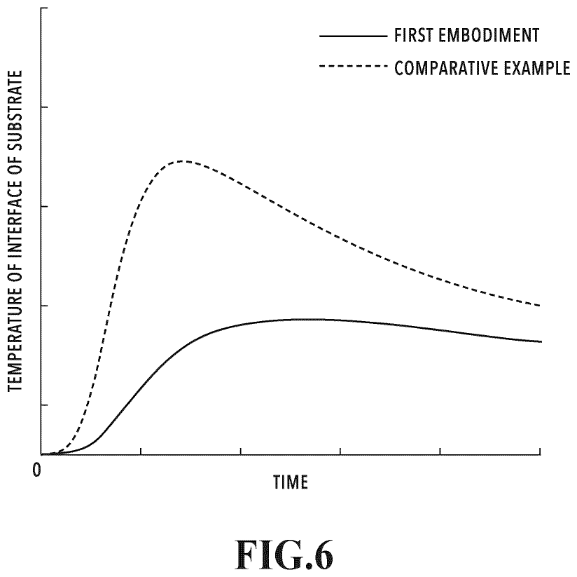

FIG. 6 is a diagram illustrating temperature transition of the interface between the base substrate 400 and the insulation layer 404 along with each ejection by the printing head 103. FIG. 6 illustrates a diagram comparing the temperature of a surface of a channel 424 of the MOS transistor 403 in a case of connecting to the drain 422 of the present embodiment and a case of connecting to the source 423 as a comparative example. A vertical axis represents the temperature, and a horizontal axis represents the time. The time at which the voltage application to the energy generation element 401 starts is the origin O, a solid line represents a case of connecting to the drain 422 (the present embodiment), and a broken line represents a case of connecting to the source 423 (the comparative example), respectively. The graph illustrated in FIG. 6 is obtained by extracting the surface temperature of the channel 424 of the MOS transistor 403 by three-dimensional simulation and plotting the temperature to the graph. It is possible to read that the surface temperature of the channel 424 of the MOS transistor 403 in a case of connecting to the drain 422 as the present embodiment is almost half of that in a case of connecting to the source 423 as the comparative example. This is because the MOS transistor 403 of the present embodiment has the offset gate structure having a long distance from a base substrate connection portion of the drain 422 to the channel 424. That is, the distance between the channel and the drain is made longer than the distance between the channel and the source, and the MOS transistor 403 has the offset gate structure in which the source, the gate, and the drain are asymmetric. Additionally, since the MOS transistor 403 of the present embodiment has the DMOS structure, a ratio between the distance from the base substrate connection portion of the drain 422 to the channel 424 and the distance from the base substrate connection portion of the source 423 to the channel 424 is further increased. The ratio is 4 to 20 times greater, and FIG. 6 is an example of 10 times greater. A threshold voltage of the MOS transistor 403 has a temperature property. The higher the temperature of the channel, the lower the threshold voltage. As an example, in a case where the channel temperature becomes 125 [° C.] from 25 [° C.], the threshold voltage of the MOS transistor 403 is reduced by 0.4 [V]. Therefore, in a case where the heat dissipation of the present embodiment is connected to the drain 422 of the MOS transistor 403, it is possible to reduce a variation in the threshold voltage of the MOS transistor 403. Thus, it is possible to suppress a failure or a false operation of the element on the element substrate due to the heat generation. Particularly, it is possible to suppress a failure or a false operation of the MOS transistor. Additionally, it is possible to improve the ejection stability of the ink.

### Second Embodiment

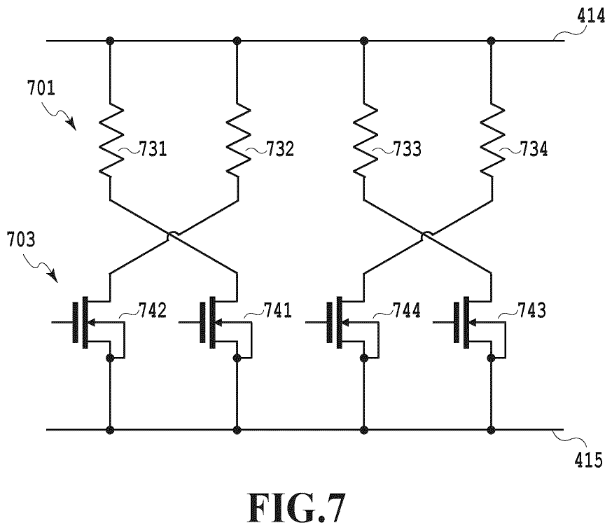

A second embodiment is described with reference to FIG. 7. FIG. 7 is a diagram illustrating a circuit configuration of the heater, which forms the printing element, and a driving circuit of the heater. In the present embodiment, a non-paired relationship is applied to the MOS transistor arranged immediately below the energy generation element. Specifically, a MOS transistor 741 that is a driving element of an energy generation element 731 is not arranged immediately below the energy generation element 731, and a MOS transistor 742 that is a driving element of another energy generation element 732 is arranged immediately below the energy generation element 731. In addition, a heat transfer line connected to a drain of the MOS transistor 742 that is the driving element of the other energy generation element 732 is arranged immediately below the energy generation element 731 driven by the MOS transistor 741. In the present embodiment, a mode in which an even-numbered row crosses an odd-numbered row is applied; however, it is not limited thereto. Any non-paired relationship such as simply shifted positions may be applied.

In the present embodiment, with the non-paired relationship of the MOS transistor arranged immediately below the energy generation element, it is possible to suppress a failure or a false operation of the MOS transistor due to a further variation in the threshold voltage. In addition, it is possible to suppress a false operation caused by thermal noise.

### Third Embodiment

As the printing head, for example, the ink jet printing head ejecting the ink has a possibility that a volatile component in the ink evaporates from the ejection port through which the ink is ejected, and the ink in the ejection port is thickened. In some cases, the thickening of the ink as described above changes the ejection velocity and the like of the ink and causes defective ejection including reduction in the droplet landing accuracy of the ink. Particularly, in a case where the ejection operation of the ink is stopped for a long time, a noticeable increase in the viscosity of the ink occurs, a solid content in the ink solidifies in the ejection port, a flow resistance in the ink is increased, and the defective ejection of the ink is likely to occur.

As one of countermeasures to the viscosity increase phenomenon of the ink as described above, a method of flowing a fresh ink into the ejection port in a liquid chamber has been known. As the method of flowing the ink, a method of arranging auxiliary resistors at the positions having asymmetric flow resistances in a flow channel, and in a case of refilling with the ink after heating and bubble generation by the auxiliary resistors, using a liquid suction flow from a flow channel side having a small flow resistance has been known. An ink circulation function using the suction flow by the auxiliary resistor can reduce the cost more than a configuration providing an ink circulation pump outside the printing head 103.

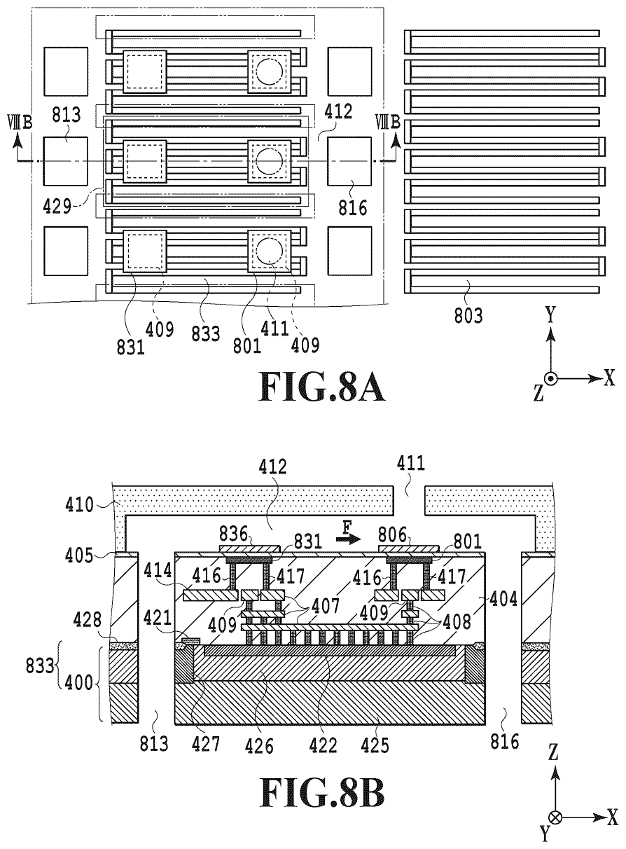

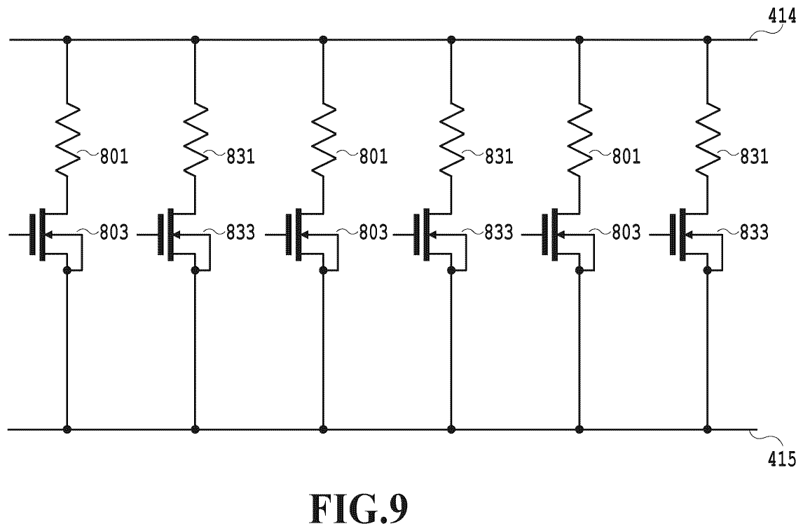

A third embodiment is described with reference to FIGS. 8A, 8B, and 9. FIG. 8A is a schematic plan view of the printing head 103. FIG. 8B is a schematic cross-sectional view of the printing head 103 taken along a cross-section line VIIIB-VIIIB in FIG. 8A. FIG. 9 is a diagram illustrating an equivalent circuit of FIG. 8A. The insulation layer 404 is arranged on the base substrate 400. Additionally, the multi-layer wiring 407 is arranged on the base substrate 400. An ejection energy generation element 801 and a flow energy generation element 831 are arranged in the insulation layer 404. A cavitation resistant layer 806 is arranged on the ejection energy generation element 801 via the insulation layer 404. A cavitation resistant layer 836 is arranged on the flow energy generation element 831 via the insulation layer 404. The ejection port 411 and the flow channel 412 are formed above the cavitation resistant layers 806 and 836 and the insulation layer 404 by using the nozzle formation member 410. Moreover, a supply port 813 and an outlet port 816 of the ink are formed to penetrate the base substrate 400 and the insulation layer 404. The supply port 813 and the outlet port 816 communicate with the flow channel 412. The supply port 813 and the outlet port 816 may have a commonalized configuration within the chip (not illustrated). The printing head 103 utilizes the heat energy of the ejection energy generation element 801 to eject the ink in the flow channel 412 from the ejection port 411. Furthermore, in the printing head 103, a circulation flow F that utilizes the heat energy of the flow energy generation element 831 to move from the supply port 813 toward the outlet port 816 is generated in the flow channel 412.

In the present embodiment, the flow energy generation element 831 is arranged in addition to the ejection energy generation element 801. Additionally, a MOS transistor 833 that is the driving element of the flow energy generation element 831 is arranged in addition to a MOS transistor 803 that is the driving element of the ejection energy generation element 801. The MOS transistor 803 or the MOS transistor 833 are arranged immediately below the ejection energy generation element 801 or the flow energy generation element 831. In the present embodiment, immediately below the ejection energy generation element 801 and the flow energy generation element 831, the MOS transistor 833 that is the driving element of the flow energy generation element 831 is arranged in a lower portion of the flow channel 412 between the supply port 813 and the outlet port 816. In addition, the MOS transistor 803 that is the driving element of the ejection energy generation element 801 is arranged outside the flow channel 412 between the supply port 813 and the outlet port 816 in planar view. As described above, the printing head 103 having the ink circulation function that requires the flow energy generation element 831 needs the MOS transistors that are twice the number of the driving elements than that in the printing head 103 without the ink circulation function. Additionally, the auxiliary resistor (the flow energy generation element 831) arranged at the position having the asymmetric flow resistance in the flow channel is also required. However, since a length of the flow channel 412 between the supply port 813 and the outlet port 816 is increased, the arrangement of the MOS transistor that is the driving element in the lower portion of the flow channel 412 between the supply port 813 and the outlet port 816 achieves further greater cost reduction.

In the present embodiment, a configuration in which the ejection energy generation element 801 and the MOS transistor 803 are arranged above the MOS transistor 833 is adopted; however, it is not limited thereto. In the arrangement in FIG. 8A, the arrangement of the MOS transistor 803 and the arrangement of the MOS transistor 833 may be switched. That is, a configuration in which the ejection energy generation element 801 and the flow energy generation element 831 are arranged above the MOS transistor 803 may be applied.

In the present embodiment, at least one of the ejection energy generation element 801 and the flow energy generation element 831 is connected to the drain of the MOS transistor 803 or the drain of the MOS transistor 833 arranged at a partially overlapping position. The MOS transistor 803 or 833 arranged at the position partially overlapping at least one of the ejection energy generation element 801 and the flow energy generation element 831 may have the offset gate structure in which the source, the gate, and the drain are asymmetric. That is, a distance between the channel and the drain is made longer than a distance between the channel and the source, and the MOS transistor 803 or 833 has the offset gate structure in which the source, the gate, and the drain are asymmetric. Additionally, the MOS transistor 803 or 833 arranged at the position partially overlapping at least one of the ejection energy generation element 801 and the flow energy generation element 831 may have the DMOS structure. Since this is described in detail in the first embodiment, detailed description is omitted.

In the present embodiment, the heat transfer line 409 is arranged immediately below the ejection energy generation element 801 and the flow energy generation element 831 and is connected to the base substrate 400. However, the present embodiment is not limited thereto. The heat transfer line 409 may be arranged immediately below the ejection energy generation element 801 or the flow energy generation element 831. As long as the heat transfer line 409 is arranged immediately below one energy generation element, it is possible to reduce the temperature increase of the interface between the base substrate 400 and the insulation layer 404 caused by the continuous ejection by the printing head 103 more than a case without the heat dissipation mode.

It is preferable to arrange the uppermost layer of the heat transfer line 409 to overlap a large proportion (for example, 50% or more) of an area of at least one of the ejection energy generation element 801 and the flow energy generation element 831 in planar view. The uppermost layer of the heat transfer line 409 may be arranged to overlap a part of the area of at least one of the ejection energy generation element 801 and the flow energy generation element 831 in planar view. Since the heat transfer line 409 is formed of the material with higher thermal conductivity than that of the material of the insulation layer 404, the heat dissipation effect is obtained as long as 10% or more of the area of at least one of the ejection energy generation element 801 and the flow energy generation element 831 overlaps the uppermost layer of the heat transfer line 409. Additionally, it is preferable to arrange the uppermost layer of the heat transfer line 409 to overlap the center of at least one of the ejection energy generation element 801 and the flow energy generation element 831 in planar view. Since this is described in detail in the first embodiment, detailed description is omitted.

In addition, in the present embodiment, the heat transfer line 409 is connected to the drain 422 of the MOS transistor 833 that is the driving element of the flow energy generation element 831 of the base substrate 400 through the via 408 and the wiring 407. The circulation flow F that utilizes the heat energy of the flow energy generation element 831 to move from the supply port 813 toward the outlet port 816 is generated in the flow channel 412. The control generating the circulation flow F needs lower accuracy than that for the control to eject the ink in the flow channel 412 from the ejection port 411 by utilizing the heat energy of the ejection energy generation element 801. Therefore, in a case where the heat dissipation mode of the present embodiment is applied and the heat dissipation is connected to the drain 422 of the MOS transistor 833, it is possible to further extend the lifetime of the MOS transistor 803. Thus, it is also possible to reduce the variation in the threshold voltage of the MOS transistor 803. Accordingly, it is possible to suppress a failure or a false operation of the element on the element substrate caused by the heat generation. Particularly, it is possible to suppress a failure or a false operation of the MOS transistor. In addition, it is also possible to further improve the ejection stability of the ink.

According to the technique of the present disclosure, it is possible to suppress a failure or a false operation of an element on an element substrate caused by heat generation.

### Other Embodiments

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-212172, filed Dec. 5, 2024, which is hereby incorporated by reference herein in its entirety.

What is claimed is:

1. An element substrate having a laminate structure, comprising, from bottom in a laminated direction of the element substrate:
a substrate of a semiconductor material;
a plurality of Metal-Oxide Semiconductor Transistors (MOS transistors) disposed on the substrate of the semiconductor material;
an insulation layer disposed on the plurality of MOS transistors; and
a plurality of energy generation elements disposed on the insulation layer and configured to be driven by the plurality of MOS transistors to generate heat to eject a liquid,
wherein each energy generation element and at least one of the plurality of MOS transistors are arranged at positions to partially overlap each other in planar view,
wherein a heat transfer line formed of a material with higher thermal conductivity than that of a material of the insulation layer is arranged in the insulation layer, and
wherein the heat transfer line is arranged at a position in which each energy generation element and a part of the heat transfer line overlap each other in planar view, and is connected to the substrate of the semiconductor material.

2. The element substrate according to claim 1, wherein
the heat transfer line is connected to a drain of the MOS transistor arranged at a position in which each energy generation element and the MOS transistor partially overlap each other in planar view.

3. The element substrate according to claim 2, wherein
the MOS transistor arranged at the position in which each energy generation element and the MOS transistor partially overlap each other in planar view has an offset gate structure in which a source, a gate, and the drain are asymmetric.

4. The element substrate according to claim 3, wherein,
in the MOS transistor arranged at the position in which each energy generation element and the MOS transistor partially overlap each other in planar view, a distance between a channel and the drain is longer than a distance between the channel and the source.

5. The element substrate according to claim 1, wherein
the MOS transistor arranged at the position in which each energy generation element and the MOS transistor partially overlap each other in planar view has a Double-diffused Metal-Oxide Semiconductor (DMOS) structure.

6. The element substrate according to claim 1, wherein
separation between segments of the MOS transistor arranged at the position in which each energy generation element and the MOS transistor partially overlap each other in planar view is source separation that is separation using a source line of the MOS transistor.

7. The element substrate according to claim 1, wherein
the heat transfer line has a multi-layer structure, and
the heat transfer line is arranged at a position in which an uppermost layer of the heat transfer line and 50% or more of an area of each energy generation element overlap each other in planar view.

8. The element substrate according to claim 1, wherein
the heat transfer line has a multi-layer structure, and
the heat transfer line is arranged at a position in which an uppermost layer of the heat transfer line and 10% or more of an area of each energy generation element overlap each other in planar view.

9. A printing head comprising the element substrate according to claim 1 to eject the liquid.

10. A printing apparatus comprising the printing head according to claim 9 to eject the liquid onto a printing medium to print an image.

11. An element substrate having a laminate structure, comprising, from bottom in a laminated direction of the element substrate:
a substrate of a semiconductor material;
a plurality of first MOS transistors and a plurality of second MOS transistors disposed on the substrate of the semiconductor material;
an insulation layer disposed on the substrate of the semiconductor material and the plurality of first MOS transistors and the plurality of second MOS transistors; and
a plurality of first energy generation elements disposed on the insulation layer and configured to be driven by the plurality of first MOS transistors to generate heat to eject a liquid; and
a plurality of second energy generation elements configured to be driven by the plurality of second MOS transistors to generate heat to flow the liquid,
wherein each first energy generation element and each second energy generation element and at least one of the plurality of first MOS transistors or at least one of the plurality of second MOS transistors are arranged at positions to partially overlap each other in planar view,
wherein a heat transfer line formed of a material with higher thermal conductivity than that of a material of the insulation layer is arranged in the insulation layer, and
wherein the heat transfer line is arranged at a position in which at least one of each first energy generation element and each second energy generation element and a part of the heat transfer line overlap each other in planar view, and is connected to the substrate of the semiconductor material.

12. The element substrate according to claim 11, wherein
the heat transfer line is connected to a drain of the first MOS transistor or a drain of the second MOS transistor arranged at a position in which at least one of each first energy generation element and each second energy generation element and the first MOS transistor or the second MOS transistor partially overlap each other in planar view.

13. The element substrate according to claim 12, wherein
the first MOS transistor or the second MOS transistor arranged at the position in which at least one of each first energy generation element and each second energy generation element and the first MOS transistor or the second MOS transistor partially overlap each other in planar view has an offset gate structure in which a source, a gate, and the drain are asymmetric.

14. The element substrate according to claim 13, wherein,
in the first MOS transistor or the second MOS transistor arranged at the position in which at least one of each first energy generation element and each second energy generation element and the first MOS transistor or the second MOS transistor partially overlap each other in planar view, a distance between a channel and the drain is longer than a distance between the channel and the source.

15. The element substrate according to claim 11, wherein
the first MOS transistor or the second MOS transistor arranged at the position in which at least one of each first energy generation element and each second energy generation element and the first MOS transistor or the second MOS transistor partially overlap each other in planar view has a DMOS structure.

16. The element substrate according to claim 11, wherein
separation between segments of the first MOS transistor or the second MOS transistor arranged at the position in which at least one of each first energy generation element and each second energy generation element and the first MOS transistor or the second MOS transistor partially overlap each other in planar view is source separation that is separation using a source line of the first MOS transistor or the second MOS transistor.

17. The element substrate according to claim 11, wherein
the heat transfer line has a multi-layer structure, and
the heat transfer line is arranged at a position in which an uppermost layer of the heat transfer line and 50% or more of an area of at least one of each first energy generation element and each second energy generation element overlap each other in planar view.

18. The element substrate according to claim 11, wherein
the heat transfer line has a multi-layer structure, and
the heat transfer line is arranged at a position in which an uppermost layer of the heat transfer line and 10% or more of an area of at least one of each first energy generation element and each second energy generation element overlap each other in planar view.

19. A printing head comprising the element substrate according to claim 11 to eject the liquid.

20. A printing apparatus comprising the printing head according to claim 19 to eject the liquid onto a printing medium to print an image.
